(19) United States
(12) Patent Application Publication
(10) Pub. No.: US 2006/0285562 A1
(43) Pub. Date: Dec. 21, 2006

(54) Semiconductor laser device

(75) Inventor: Nobuhiro Nishiyama, Osaka (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/448,738

(22) Filed: Jun. 8, 2006

(30) Foreign Application Priority Data
Jun. 16, 2005 (JP) 2005-176679

(51) Int. Cl. H01S 3/13

(52) U.S. Cl. 372/29.02; 372/29.011

(57) ABSTRACT

A first reflective surface is disposed on the optical axis of monitor light emitted from a semiconductor laser element, and a second reflective surface is disposed on an inner surface of a lid portion. The first reflective surface is so inclined that the monitor light traveling on the optical axis is reflected on the first reflective surface and is then reflected on the second reflective surface so as to strike, as a second reflected light, a light-receiving surface of a light-receiving element. The light-receiving surface is thus struck not only by the monitor light traveling off the optical axis directly from semiconductor laser element but also by the second reflected light, which has higher intensity than the light traveling off the optical axis.

This nonprovisional application claims priority under 35 U.S.C. §119(a) on Patent Application No. 2005-176679 filed in Japan on Jun. 16, 2005, the entire contents of which are hereby incorporated by reference.

### BACKGROUND OF THE INVENTION

1. Field of the Invention

The present invention relates to a semiconductor laser device including a light-receiving element for receiving monitor light.

2. Description of Related Art

Even when a semiconductor laser device is fed with a constant drive current, the laser light output of the semiconductor laser device varies greatly with temperature. To drive a semiconductor laser device on an APC (automatic power control) basis, that is, to keep the laser light output thereof constant, of the laser light emitted from both ends of the semiconductor laser device, the part emitted from one end is received, as monitor light, with a light-receiving element such as a photodiode so that, based on the current produced as a result, the drive current fed to the semiconductor laser device is controlled.

For the sake of productivity and work efficiency, a frame-type semiconductor laser device is generally so structured that the optical axis of the laser, including the monitor light, is parallel to the light-receiving surface of the light-receiving element. In this structure, however, of the monitor light, only the part traveling off the optical axis and thus having low intensity is detected on the light-receiving surface of the light-receiving element. Thus, the portion of monitor light received by the light-receiving surface of the light-receiving element is small, and the light-receiving element yields an accordingly low output. This makes it difficult to control the drive current, and may cause the semiconductor laser device to break down when too much drive current is passed through it.

With the above described disadvantage in mind, the semiconductor laser device 110 proposed in JP-A-2003-31885 is built, as shown in FIG. 5, as a frame-type semiconductor laser device that is provided with a leadframe 111 on which a ceramic substrate 113 and a light-receiving element 115 are mounted, with a semiconductor laser element 114 mounted on the ceramic substrate 113. The semiconductor laser element 114 and the light-receiving element 115 are arranged in such a manner that the optical axis 120 of the monitor light emitted from the semiconductor laser element 114 is parallel to the light-receiving surface 115a of the light-receiving element 115. The semiconductor laser device 110 further has an enclosure 118, whose inner surface is given a high optical reflectivity by surface treatment to form a reflective surface 117. Thus, of the monitor light traveling off the optical axis 120, not only the part emitted in the direction of the light-receiving surface 115a of the light-receiving element 115 but also the part 127 emitted in the direction of the package 118 so as to be reflected by the reflective surface 117 strikes the light-receiving surface 115a. In this way, it is possible to increase the portion of the monitor light that strikes the light-receiving surface 115a of the light-receiving element 115, and thereby to increase the output of the light-receiving element 115.

In the semiconductor laser device proposed in JP-A-2003-31885, however, the high-intensity part of the monitor light that travels on the optical axis does not strike the light-receiving surface 115a of the light-receiving element 115, and thus the portion of the monitor light that actually strikes the light-receiving surface 115a is not remarkably larger than in a case where no reflective surface 117 is provided.

### SUMMARY OF THE INVENTION

An object of the present invention is to provide a semiconductor laser device having a structure that permits part of monitor light emitted by a semiconductor laser device and traveling on the optical axis to be received by a light-receiving surface of a light-receiving element, thereby increasing the amount of light received by the light-receiving surface so as to increase the output of the light-receiving element, based on which a drive current is appropriately controlled.

To achieve the above object, according to the present invention, a semiconductor laser device provided with a semiconductor laser element, a light-receiving element that receives monitor light emitted from the semiconductor laser element, and a leadframe on which the semiconductor laser element and the light-receiving element are mounted is further provided with a first reflective surface that is disposed on the optical axis of the monitor light and a second reflective surface that is disposed on the optical axis of first reflected light that results from the monitor light being reflected from the first reflective surface. Here, second reflected light resulting from the first reflected light being reflected from the second reflective surface strikes the light-receiving surface of the light-receiving element.

According to the present invention, preferably, the above structured semiconductor laser device is further provided with a base portion arranged on the leadframe and a lid portion arranged on the base portion so as to cover the semiconductor laser element and the light-receiving element. Here, the first reflective surface is located on the base portion and the second reflective surface is located on the interior surface of the lid portion.

According to the present invention, preferably, in the above structured semiconductor laser device, the semiconductor laser element is mounted on the leadframe with a submount interposed in between, and the height from the leadframe to the semiconductor laser element is greater than the height from the leadframe to the light-receiving surface of the light-receiving element.

According to the present invention, preferably, in the above configured semiconductor laser device, the light-receiving element is mounted on the submount.

Thus, according to the present invention, the monitor light traveling on the optical axis and thus having higher intensity than the monitor light traveling off the optical axis is reflected on the first reflective surface and then on the second reflective surface so as to strike the light-receiving surface of the light-receiving element. This helps increase the amount of light striking the light-receiving surface, and thus helps increase the output of the light-receiving element. Based on this output, a semiconductor laser device according to the present invention can properly control the drive current thereof.

Moreover, according to the present invention, the semiconductor laser element is mounted on the leadframe with a submount interposed in between, and the height from the leadframe to the semiconductor laser element is greater than the height from the leadframe to the light-receiving surface of the light-receiving element. This helps increase the portion of the monitor light that strikes the light-receiving surface of the light-receiving element directly from the semiconductor laser element. Thus, the drive current can be controlled more properly.

Moreover, according to the present invention, the light-receiving element is mounted on the submount. This makes it possible, when the semiconductor laser device is fabricated, to properly arrange the semiconductor laser element and the light-receiving element simply by arranging the submount on the leadframe. This helps eliminate the step of positioning the light-receiving element on the leadframe in such a way that monitor light strikes the light-receiving element, and thus helps reduce fabrication cost.

### BRIEF DESCRIPTION OF THE DRAWINGS

FIG. 1 is a sectional view schematically showing a semiconductor laser device embodying the present invention;

FIG. 2 is a block diagram illustrating the relationship among a semiconductor laser element, a light-receiving element, a power supply, and a controller of the semiconductor laser device embodying the present invention;

FIG. 3 is a sectional view schematically showing a modified example of the semiconductor laser device embodying the present invention;

FIG. 4 is a sectional view schematically showing another modified example of the semiconductor laser device embodying the present invention; and

FIG. 5 is a sectional view schematically showing a conventional semiconductor laser device.

### DETAILED DESCRIPTION OF PREFERRED EMBODIMENTS

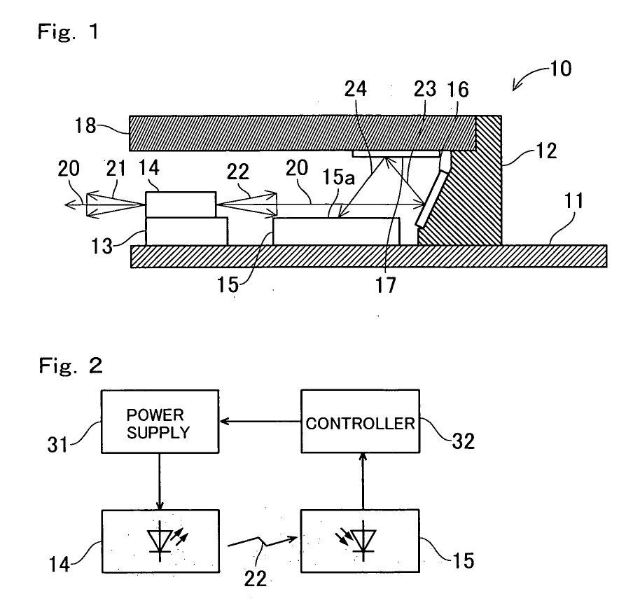

Hereinafter, embodiments of the present invention will be described with reference to the accompanying drawings. FIG. 1 is a sectional view schematically showing a semiconductor laser device embodying the present invention. FIG. 2 is a block diagram showing the relationship among a semiconductor laser element, a light-receiving element, a power supply, and a controller of the semiconductor laser device embodying the present invention.

As shown in FIG. 1, the semiconductor laser device 10 is provided with a leadframe 11 formed of a metal, a base portion 12 formed of a resin or the like and fitted on the leadframe 11, and a lid portion 18. On the leadframe 11, a submount 13 and a light-receiving element 15 are mounted. On the submount 13, a semiconductor laser element 14 is mounted.

The semiconductor laser element 14 is in the form of a chip produced by joining together and then cleaving a p-type semiconductor and an n-type semiconductor. When a voltage is applied between the p-type and n-type semiconductors so as to pass a drive current, their junction, namely a p-n junction layer, emits light. This light is then amplified by resonance between two mutually parallel mirror surfaces that are formed at opposite cleavage surfaces with different reflectivities, so that, through the mirror surface having the lower reflectivity, main laser light 21 emerges. Also through the mirror surface having the higher reflectivity, laser light having lower intensity than the main laser light 21 leaks out, and this light is used as monitor light 22.

The semiconductor laser element 14 is arranged in such a manner that the optical axis 20 of the main laser light 21 and the monitor light 22 is parallel to the leadframe 11. The light-receiving element 15, such as a photodiode, is arranged in such a manner that the height from the leadframe 11 to the light-receiving surface 15a thereof is approximately equal to the thickness of the submount 13 and that the light-receiving element 15 is parallel to the optical axis of the monitor light 22. Thus, the monitor light 22 traveling off the optical axis 20 directly strikes the light receiving element 15. The lid portion 18 has an opening at the right in FIG. 1, and this opening is closed by the base portion 12. The lid portion 18 is fitted in such a way as to enclose the submount 13 and the light-receiving element 15. Here, the height from the leadframe 11 to the light-receiving surface 15a may be other than described above so long as it is smaller than the height from the leadframe 11 to the optical axis 20.

As shown in the block diagram FIG. 2, when a driving current is passed from a power supply 31, the semiconductor laser element 14 emits the main laser light 21 and the monitor light 22. This monitor light 22 is received by the light-receiving element 15, based on the output of which a controller 32 performs APC, whereby the drive current from the power supply 31 is so controlled as to keep the intensity of the main laser light 21 and the monitor light 22 constant.

In this embodiment, on the surface of the base portion 12 that is struck by the monitor light 22, a plating is formed to form a first reflective surface 16. The first reflective surface 16 is so inclined that the monitor light 22 traveling on the optical axis 20 is reflected toward the lid portion 18. Moreover, on and around the part of the inner surface of the lid portion 18 that is struck by first reflected light 23 resulting from the monitor light 22 traveling on the optical axis 20 being reflected from the first reflective surface 16, a plating is formed to form a second reflective surface 17. The inclination angle of the first reflective surface 16 is so set that second reflected light 24 resulting from the first reflected light 23 being reflected from the second reflective surface 17 strikes the light-receiving surface 15a of the light-receiving element 15.

With this structure, part of the monitor light 22 that travels off the optical axis 20 strikes the light-receiving surface 15a of the light-receiving element 15; also, part of the monitor light 22 that travels on the optical axis and that has stronger intensity than the part traveling off the optical axis is reflected by the first and second reflective surfaces 16 and 17, and then strikes the light-receiving surface 15a of the light-receiving element 15. This increases the portion of the monitor light 22 that strikes the light-receiving surface 15a of the light-receiving element 15, and thus increases the output of the light-receiving element 15. Thus, based on the current produced by the light-receiving element 15 receiving the monitor light 22, it is possible to control the drive current properly.

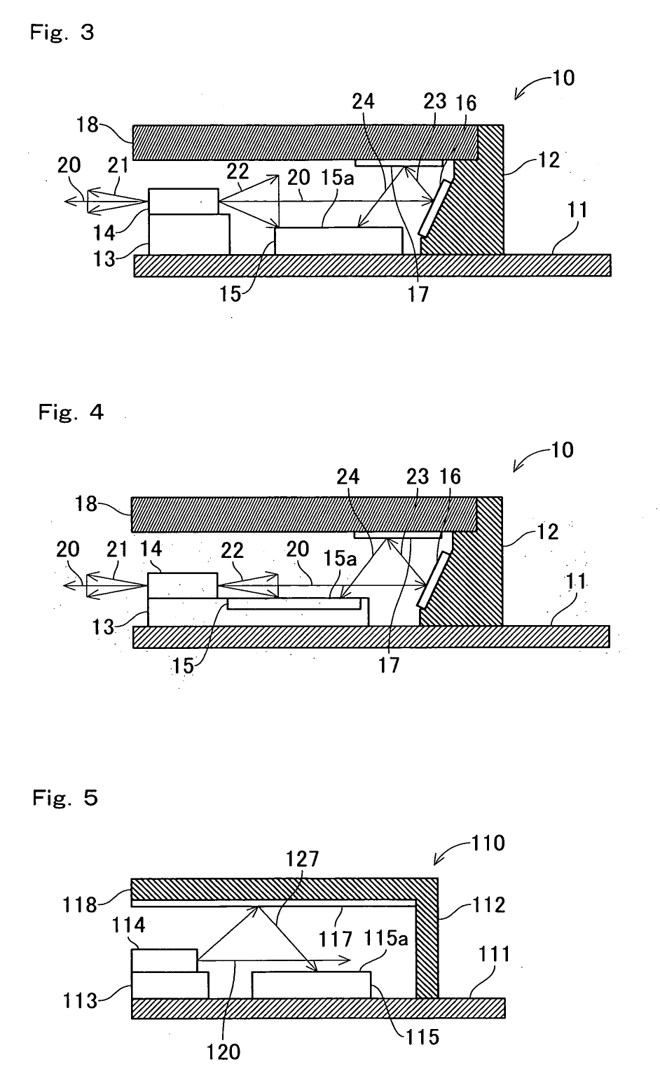

Moreover, in this embodiment, as shown in FIG. 3, the thickness of the submount 13 may be so set that the height from the leadframe 11 to the semiconductor laser element 14 is greater than the height from the leadframe 11 to the light-receiving surface 15a. This permits more of the monitor light 22 traveling off the optical axis 20 to strike the light-receiving surface 15a directly from the semiconductor laser element 14 than in the case shown in FIG. 1 where the distance from the leadframe 11 to the semiconductor laser element 14 is approximately equal to the distance from the leadframe 11 to the light-receiving surface 15a. This helps further increase the portion of the monitor light 22 that strikes the light-receiving surface 15a.

Moreover, in this embodiment, as shown in FIG. 4, the submount 13 may have a light-receiving element 15 formed on the top surface thereof. In this case, when the semiconductor laser device 10 is fabricated, simply by arranging the submount 13, which has the semiconductor laser element 14 formed thereon, on the leadframe 11, it is possible to arrange also the light-receiving element 15. This helps make the fabrication process of the semiconductor laser device 10 simpler than in the case shown in FIG. 1 where the submount 13 and the light-receiving element 15 are separately arranged on the leadframe 11. Also, it is no longer necessary to position the light-receiving element 15 on the leadframe 11 in such a way that the second reflected light 24 strikes the light-receiving surface 15a.

Moreover, in this embodiment, materials having different reflectivities may be used to form the platings forming the first and second reflective surfaces 16 and 17. By giving the platings different reflectivities, it is possible to adjust the portion of the monitor light striking the light-receiving element 15 to suit the sensitivity thereof, and this makes it possible to control the drive current with high precision. A plurality of lid portions 18 having different platings formed as the second reflective surface 17 may be prepared. This makes it possible to adjust the portion of the monitor light striking the light-receiving element 15 to suit the sensitivity thereof simply by selecting an appropriate one of the lid portions 18 and hence without changing the structure of, for example, the leadframe 11 or the submount 13.

In this embodiment, the first and second reflective surfaces 16 and 17 may be formed otherwise than by plating; for example, they may be formed by vapor-depositing metal such as aluminum, or by laying a mirror-surfaced metal sheet, or by any other manner, so long as they reflect light.

Semiconductor laser devices according to the present invention can be used as high-precision light source for reading signals from optical discs such as CDs, CD-Rs, DVDs, and DVD-Rs.

What is claimed is:

1. A semiconductor laser device comprising:
a semiconductor laser element;
a light-receiving element for receiving monitor light emitted from the semiconductor laser element;
a leadframe on which the semiconductor laser element and the light-receiving element are mounted;
a first reflective surface located on an optical axis of the monitor light; and
a second reflective surface located on an optical axis of first reflected light resulting from the monitor light being reflected from the first reflective surface,
wherein second reflected light resulting from the first reflected light being reflected from the second reflective surface strikes a light-receiving surface of the light-receiving element.

2. The semiconductor laser device of claim 1, further comprising:
a base portion arranged on the leadframe; and
a lid portion arranged on the base portion so as to cover the semiconductor laser element and the light-receiving element,
wherein the first reflective surface is located on the base portion and the second reflective surface is located on an inner surface of the lid portion.

3. The semiconductor laser device of claim 1,
wherein the semiconductor laser element is mounted on the leadframe with a submount interposed in between, and a height from the leadframe to the semiconductor laser element is greater than a height from the leadframe to the light-receiving surface of the light-receiving element.

4. The semiconductor laser device of claim 3,
wherein the light-receiving element is arranged on the submount.
